(19) United States
(12) Patent Application Publication
(10) Pub. No.: US 2012/0071153 A1
(43) Pub. Date: Mar. 22, 2012

(54) Receive Signal Processing In Wireless Networks

(75) Inventors: Krishna Balachandran, Morganville, NJ (US); Joseph H. Kang, Belle Mead, NJ (US); Kemal M. Karakayali, Highland Park, NJ (US); Kiran M. Rege, Marlboro, NJ (US)

(73) Assignee: Alcatel-Lucent USA Inc., Murray Hill, NJ (US)

(21) Appl. No.: 12/885,126

(22) Filed: Sep. 17, 2010

(51) Int. Cl. H04W 4/00

(52) U.S. Cl. 455/422.1

(57) ABSTRACT

Among the various methods proposed to address interference problems in wireless networks, two promising ones are: Network Multi-Input-Multi-Output (often referred to as Network MIMO) decoding (which employs joint MIMO receiver processing of signals received at multiple antennas); and Multi-Cell Successive Interference Cancellation (MC-SIC). These methods have complementary strengths and limitations when implemented in a practical setting. The approach described herein attempts to combine the strengths of these two methods while working within the constraints imposed by practical implementations to provide a viable hybrid solution.

### FIELD OF THE INVENTION

The present invention relates generally to communications and, in particular, to receive signal processing in wireless networks.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

Uplink transmissions (also referred to as reverse-link transmissions) in cellular networks comprising multiple base stations often suffer from excessive interference due to out-of-cell transmissions. In such networks, typically, mobile stations (also referred to as, simply, mobiles) communicating with different base stations are scheduled for transmission independently by the respective base stations. We refer to the base station with which a mobile station is communicating as the latter's primary base station. (Alternatively, we also refer to this base station as the base station connected to the mobile station.) When a mobile station is reasonably close to base stations other than its primary base station, it is likely to cause significant interference at those base station's receivers. (Here closeness is defined in terms of radio conditions, not just the physical distance.) The transmissions of the (interfering) mobile may not be decodable at the receivers of the base stations other than its primary base stations, which means that those receivers cannot employ local procedures to cancel the interference caused by the mobile. Thus, unless the Signal-to-Interference+Noise-Ratio (SINR) of a mobile's transmissions is high enough at its primary base station, it cannot be successfully decoded. This often limits the signaling rates that can be achieved in today's cellular networks, which are, often, interference-limited.

Therefore, new approaches and techniques that are able to address such interference-related issues would advance communications generally.

### BRIEF DESCRIPTION OF THE DRAWINGS

FIG. 1 is a simplified illustration depicting a wireless network.

FIG. 2 is a block diagram depicting overlapping clusters in a cluster-based approach to network MIMO.

FIG. 3 is an simplified illustration depicting an example of multi-cell successive interference cancellation (SIC).

FIG. 4 is a block diagram depicting how transmission resources are typically organized for communications in OFDMA and SC-FDMA systems.

FIG. 5 is a block diagram depicting an example of resource block allocation to multiple mobile stations.

FIG. 6 is a block diagram depicting example clusters in a network with sectorized antennas, in accordance with various embodiments of the present invention.

FIG. 7 is a block diagram depicting a clustering example in which each cluster includes sectors of the same cell, in accordance with various embodiments of the present invention.

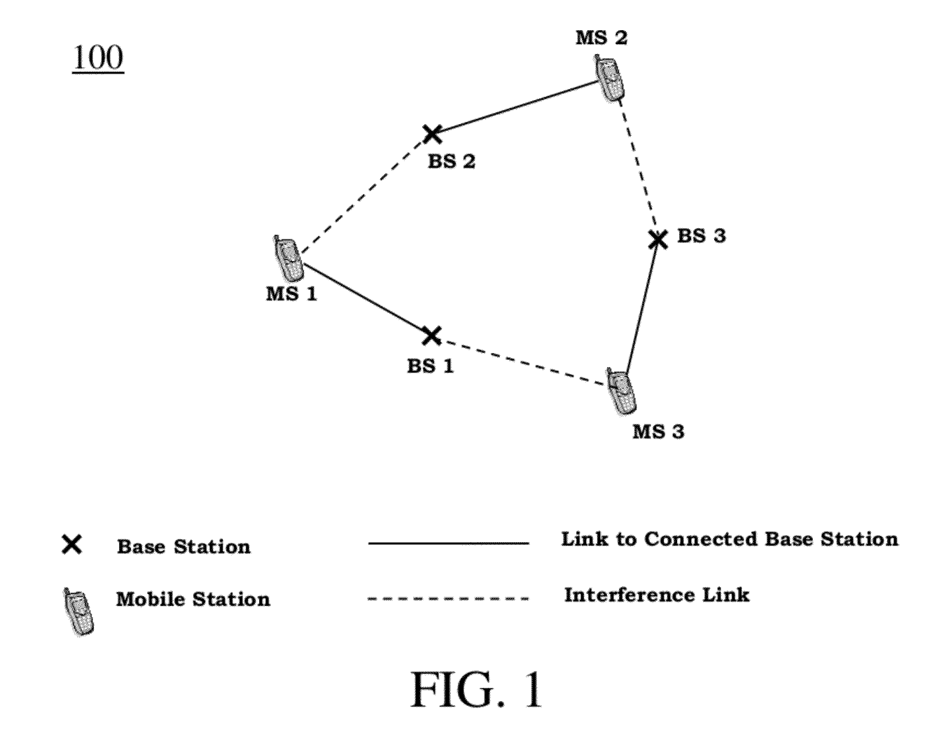

Specific embodiments of the present invention are disclosed below with reference to FIGS. 1-7. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

Various methods are provided to address some of the current interference-related issues in wireless networks. One method includes performing, by a first cluster processor of a first cluster, joint processing of received signal vectors, each corresponding to a receive antenna associated with the first cluster. The first cluster processor also sends messaging requesting information from a second cluster processor to aid the first cluster processor in decoding signals from a transmitting device. An article of manufacture is also provided, the article comprising a processor-readable storage medium storing one or more software programs which when executed by one or more processors performs the steps of this method.

Many embodiments are provided in which the method above is modified. Some embodiments further include receiving, by the first cluster processor in response to the messaging requesting information, decoded information bits corresponding to at least one interfering device and then, in certain embodiments, employing, by the first cluster processor, interference cancellation using at least a portion of the decoded information bits received in an attempt to decode signals from the transmitting device. Some embodiments further include receiving, by the first cluster processor from another cluster processor, messaging requesting information to aid that other cluster processor in decoding signals and then, in certain embodiments, identifying, based on the received messaging, at least one interfering device for which the first cluster processor has decoded information bits and responding to the received messaging with decoded information bits corresponding to the at least one interfering device. In some embodiments, the first cluster comprises at least one of a plurality of sectors or a plurality of cells. In other embodiments, the first cluster comprises sectors associated only with the same base station.

A cluster processor apparatus is also provided. The cluster processor is configured to communicate with other devices in the system and is operative to perform joint processing of received signal vectors, each corresponding to a receive antenna associated with the first cluster, and to send messaging requesting information from a second cluster processor to aid the present cluster processor in decoding signals from a transmitting device. Depending on the embodiment, the cluster processor is further operational to perform any one or combination of the modifications described above with respect to the method.

Another cluster processor apparatus is also provided. This cluster processor includes a network interface adapted to send and receive messaging using at least one communication protocol and a processing unit, communicatively coupled to the network interface. The processing unit is adapted to perform joint processing of received signal vectors, each corresponding to a receive antenna associated with a first cluster, the first cluster being associated with the present cluster processor, and adapted to send, via the network interface, messaging requesting information from a second cluster processor to aid the present cluster processor in decoding signaling from a transmitting device. Depending on the embodiment, this cluster processor is also further operational to perform any one or combination of the modifications described above with respect to the method.

### DETAILED DESCRIPTION OF EMBODIMENTS

To provide a greater degree of detail in making and using various aspects of the present invention, a description of our approach to improving the performance of interference-limited networks and a description of certain, quite specific, embodiments follows for the sake of example. FIGS. 1-7 are referenced in an attempt to illustrate some examples of specific embodiments of the present invention and/or how some specific embodiments may operate/perform.

Among the various methods proposed to address this problem, two promising ones are: 1) Network Multi-Input-Multi-Output (often referred to as Network MIMO) decoding (which employs joint MIMO receiver processing of signals received at multiple base stations); and 2) Multi-Cell Successive Interference Cancellation (MC-SIC). While both of these methods hold the promise of substantially improving the performance of interference-limited cellular networks, they have complementary strengths and limitations when implemented in a practical setting. The proposed approach attempts to combine the strengths of these two methods while working within the constraints imposed by practical implementations.

### Network MIMO

As far as uplink (and downlink as well) transmissions are concerned, today's cellular networks essentially carry out signal processing (e.g. beamforming) on the signals received at one or more antennas of the primary serving cell. That is, on each resource block (e.g. a block on the time-frequency plane in an Orthogonal-Frequency-Division-Multiple-Access (OFDMA) system), each base station independently tries to decode the transmissions from the mobile station(s) connected to it and scheduled for transmission over that resource block. In doing so, it only uses the received signals at its own antennas (single output). If the signals received at the base station are affected by strong interference from mobiles connected to other base stations, it may not be possible to decode the desired signal. In an interference-limited system, several base stations may be unable to extract the signals received from their respective mobile stations because of mutually destructive interference they cause to one another.

The Network MIMO approach takes a radically different approach to uplink signal processing. In this approach, the antennas of all the base stations in a network are treated as a single distributed antenna array, and the signals received at all of the antennas in this array are processed together using well-known techniques, e.g. joint Minimum-Mean-Squared-Error (joint MMSE) based filtering, to extract the signals transmitted by different mobile stations. In this approach, even if the signals received at any base station have a poor SINR because of excessive interference, the distinct “spatial signature” associated with the signals received from different mobile stations makes it possible to extract them with little degradation when processed together in the multi-dimensional space (associated with the distributed antenna array). As a result, significantly higher data rates can be achieved if the uplink transmissions are processed via the Network MIMO approach. The following example illustrates what is meant by “spatial signature” associated with a mobile's signal and how it facilitates signal extraction in a Network MIMO system.

Consider the network 100 shown in FIG. 1 comprising three mobile stations, MS 1, MS 2 and MS 3, connected respectively to base stations BS 1, BS 2 and BS 3. The channel coefficient between mobile i (i=1, 2, or 3) and base station j (j=1, 2, or 3) is denoted by hⱼᵢ. Let the signal transmitted by mobile i (i=1, 2 or 3) be denoted by xᵢ and the signal received by base station j be denoted by yⱼ. The received signal yⱼ can be written as

$${y}_{j} = {\sum }_{i = 1}^{3} {h}_{ji} {x}_{i} + {n}_{j} , \qquad ( 1 )$$

where nⱼ represents the thermal noise at the receiver of base station j. In matrix form, we can write

y=Hx+n, (2)

where for i, j=1, 2, and 3, the jth entry of y is yⱼ, the ith entry of x is xᵢ, and the └i,j┘th entry of H is hᵢⱼ. Now, consider the specific case where H has the form shown below:

$$H = [ \begin{matrix}1 & 1 & 0 \\ 0 & 1 & 1 \\ 1 & 0 & 1\end{matrix} ] . \qquad ( 3 )$$

With the channel matrix H as shown above, each desired signal at the base station receiver (e.g. from mobile station 1 at base station 1) experiences interference from an equally strong signal from a mobile station connected to a neighboring base station. As a result, the SINR associated with the desired signals at the three base stations is rather low (less than 0 dB if all three mobiles use the same transmit power), which means that high data rates cannot be sustained between any mobile station and the corresponding base station if standard single-base-station processing is employed.

In contrast, with the Network MIMO approach, the received signals at all three base stations are processed together to extract the signals transmitted by the three mobile stations. If one adopts this approach, the distinct spatial signatures of the signals from the three mobile stations reflected in the linear independence of the columns of the channel matrix, allow one to completely nullify the effect of interference so that the signals from the three mobiles can be extracted at a very high signal-to-noise ratio (SNR). The resulting sustainable data rates can be significantly higher than what was possible with the single-base-station approach.

Ideally, a Network MIMO approach to signal processing would involve treating the antennas of all base stations in a cellular network as a single array and processing the corresponding received signals together. However, this is impractical in any network of moderate to large size owing to several factors: On the uplink of a cellular network, it would involve sending signal samples from hundreds or thousands of antennas to a common (centrally located) processing site, which is likely to strain the capacity of the backhaul links close to the processing site; it would involve estimation of channel coefficients for mobile stations that are distant from the base stations computing these estimates, which will tend to make them noisy and unreliable; it would involve inversion of large matrices, which is fraught with mathematical and computational difficulties; it is also likely to increase the processing delay due to the fact that the received signal samples have to be carried to a distant processing site over the backhaul network. In order to address these issues a cluster-based approach to Network MIMO has been proposed.

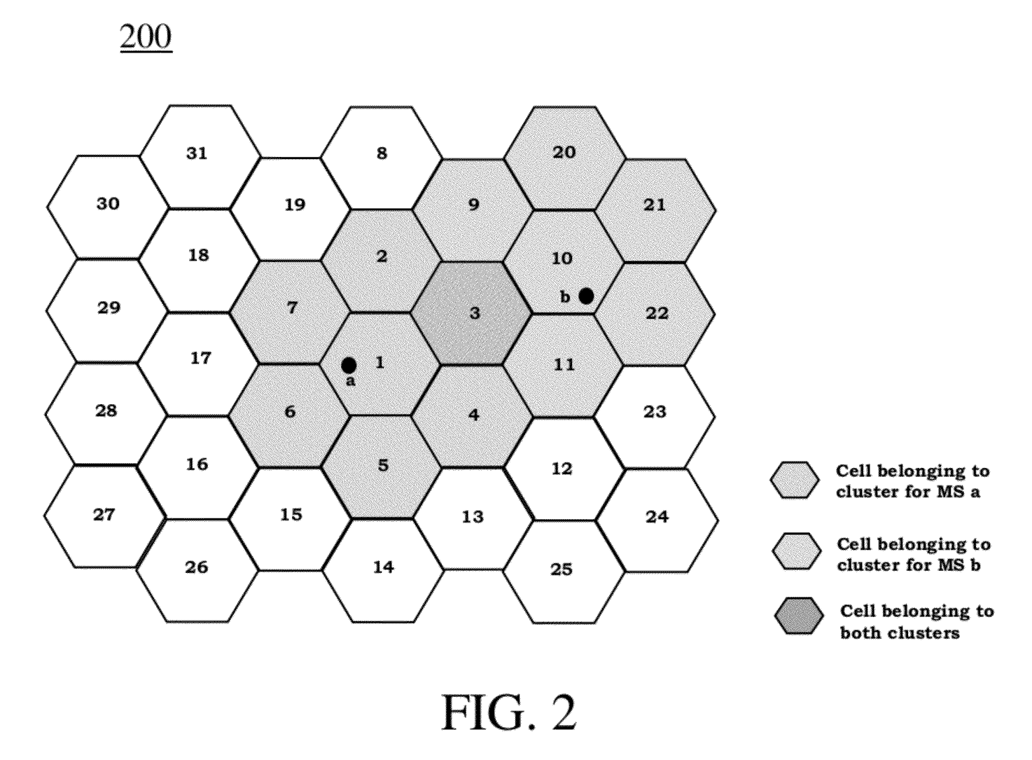

The example shown in FIG. 2 illustrates the cluster-based approach to network MIMO. (This example uses overlapping clusters.) In cluster-based Network MIMO, the base station (or cell) connected to a mobile station and a few surrounding base stations form a cluster for processing the transmissions of that mobile station. Thus, for processing a mobile station's transmissions, only the antennas associated with base stations in the cluster corresponding to that mobile station are treated as an antenna array and their received signals are jointly processed to extract its transmissions. Note that with overlapping clusters, a base station or cell can find itself included more than one cluster. For instance, one can see that the cluster associated with mobile station a in wireless network 200 of FIG. 2 includes cells 1, 2, 3, 4, 5, 6, and 7, whereas the cluster associated with mobile station b includes cells 10, 20, 21, 22, 11, 3, and 9. Thus, one can see that cell 3 appears in the cluster associated with mobile station a as well as mobile station b. The joint processing of signals received at different base stations in a cluster may be done at the base station that is at the center of the cluster. (Thus, for instance, the joint processing of signals for the cluster associated with mobile station a in FIG. 2 will be done at the base station corresponding to cell 1.) To that end, each base station in a cluster needs to send its received signal samples to the base station at the center of that cluster. Since each base station, typically, is included in several clusters, what this means is that each base station sends the same set of received signal samples to multiple base stations in its neighborhood. This can lead to significant increase in the traffic carried over backhaul links in the network. However, it avoids the kind of concentration of traffic that can happen around central facilities if a centralized approach is used.

The cluster-based approach also avoids some of the other problems associated with the case where the entire cellular network is treated as single antenna array. Specifically, with appropriately sized clusters, it avoids the mathematical and computational difficulties involved in dealing with large channel matrices; it also avoids the problem of noisy channel estimates that is inevitable if a large cellular network is treated as a single antenna array. Most significantly, it makes the implementation of the Network MIMO method feasible in any network of moderate to large size.

While the Network MIMO method using a cluster-based approach provides all of these benefits, it has some limitations as well. These limitations stem from the fact that edge effects limit the efficacy of any cluster-based approach since the edge cells experience significant interference from nearby cells not included in the cluster, and network MIMO provides no way to “orthogonalize” these out-of-cluster signals. Also, each cluster processes its signals independently, which means that successful decoding of some signals in one cluster does not help the decoding process at other, neighboring clusters where these signals may have caused significant interference. These problems limit the performance of Network MIMO systems using overlapping clusters.

### Multi-Cell Successive Interference Cancellation

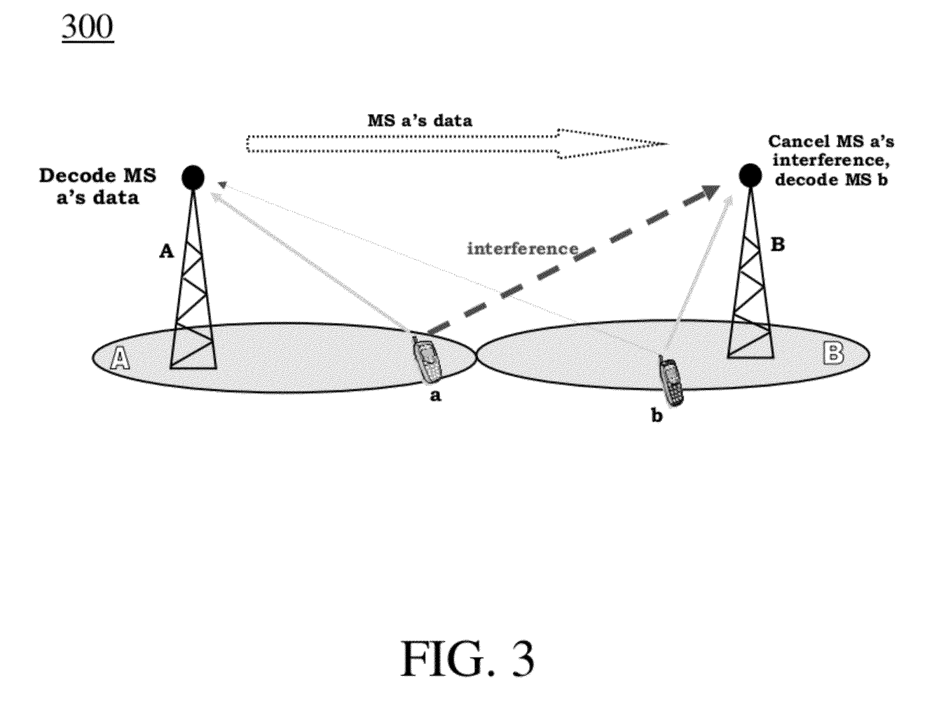

The basic idea underlying multi-cell SIC is quite simple. Consider the example illustrated in FIG. 3. In network 300, mobile station b's primary base station, base station B, cannot decode the former's transmissions because of strong interference caused by the signals from mobile station a. However, if base station A, the primary base station of mobile station a, can decode the latter's transmissions, it can send the decoded information bits along with some additional information (e.g. the modulation and coding scheme used by mobile station a) to base station B which can reconstruct the signal from mobile station a as seen at base station B's receiver. The reconstructed signal can be subtracted out of the overall received signal at base station B's receiver, leading to an improved SINR as far as the desired signal (i.e. that associated with mobile station b) is concerned. The improved SINR is likely to significantly enhance the decodability and hence the achievable rates of the desired signal. This, in essence, is what is involved in multi-cell SIC.

Multi-cell SIC has many strengths that are comparable and sometimes complementary to those of Network MIMO. It has the potential to significantly improve the achievable rates of desired signals through interference suppression. From a practical standpoint, it imposes a lighter load on the backhaul links (in comparison to Network MIMO systems) since carrying information bits between base stations is, typically, significantly more efficient than carrying received signal samples. (The latter can easily impose one to two orders of magnitude higher load on the backhaul links.) Unlike cluster-based Network MIMO systems, multi-cell SIC allows the benefits of interference cancellation to propagate through the network (i.e., across cell clusters). The decoding of a signal at a base station can lead to interference cancellation at some other base station, resulting in that base station being able to decode its desired signal. This latter can then lead to more interference cancellation and signal decoding at a few more base stations, and so on. This propagation of improved decodability via interference cancellation has the potential to expand the domain of interactions for multi-cell SIC well beyond typical cluster sizes in practical Network MIMO implementations. As a result, one can see multi-cell SIC outperforming cluster-based Network MIMO in certain scenarios.

Multi-cell SIC also has some limitations in comparison to Network MIMO. The major one of these can be attributed to the following fact: In order for the process of interference cancellation to be triggered and propagated through the network, some of the received signals need to be decodable at their respective base stations without any help from other base stations (via interference cancellation). As a consequence, the decoding process can get into deadlocks in scenarios where signals from a set of mobile stations cause significant interference to one another, rendering their respective base stations unable to decode any of those signals. For instance, consider again the example in FIG. 1, where because of the overall level of interference at each base station, the SINR associated with each mobile station (as measured at the corresponding base station) is low (less than 0 dB). Since in multi-cell SIC, the initial attempt at decoding takes place independently at each base station, none of the mobiles' signals will be decodable at their respective base stations unless at least one of them uses a rather low data rate (that is decodable at a low SINR). As a result, the process of interference cancellation will never be triggered. In contrast, as we saw earlier, a Network MIMO-based approach would jointly process the received signals at all three base stations, which makes it possible to exploit the distinct spatial signatures of the three mobiles (which become visible only if the received signals at all three base stations are processed together.) As a consequence, all three mobile stations would be able to transmit their signals at a high data rate.

It can be concluded, in view of the foregoing discussion, that cluster-based Network MIMO and multi-cell SIC are both promising techniques that have strengths as well as some limitations. Moreover, the strengths of these techniques are somewhat complementary. The proposed approach, described in detail in the subsequent sections, combines these strengths to come up with a method for processing uplink transmissions in cellular systems that can significantly improve the uplink performance of these networks.

### Hybrid Network MIMO—Successive Interference Cancellation System

The key strength of Network MIMO systems is that joint processing of signals received at antennas associated with multiple base stations leads to expanded spatial dimensionality of received signal vectors which in turn makes it far more likely that the spatial signatures associated with different transmitted signals will be easily distinguishable. This makes it possible to extract the transmitted signals with relatively little interference from one another. On the flip side, Network MIMO systems implemented with practical cluster sizes do not mitigate interference from nodes not included in a cluster. In contrast, as we saw earlier, a multi-cell SIC system does not benefit from increased dimensionality of received signal vectors; however, it allows improved decodability to propagate from one part of the network to another. The proposed approach leverages the strengths of these two base approaches while removing their respective shortcomings. Specifically, as in a cluster-based Network MIMO system, it carries out joint processing of signals received at multiple base stations; however, after each round of decoding within its clusters, it allows the clusters to exchange decoded signals, which can then be used for interference cancellation before the next round of decoding. By adopting cluster-based joint processing (a la Network MIMO), the proposed approach benefits from an increased dimensionality of received signal processing; and by allowing inter-cluster exchange of decoded signals for interference cancellation, it enables propagation of interference cancellation benefits between different parts of the network through improved decidability in every cluster. In what follows, we present a detailed description of embodiments of the proposed approach using an illustrative example.

Consider a cellular network, such as the network 200 in FIG. 2, comprising multiple base stations and mobile terminals. In order to simplify description of the ideas embodied in our approach, we assume base stations with omni-directional antennas. (Those familiar with the art can immediately see how our approach naturally extends to the case where base stations have sectorized antennas. Specifically, our approach can be applied to the multi-sector case by treating each antenna sector at a base station as a separate base station.) The coverage area of a base station is referred to as a cell. When there is no possibility of confusion, we use the terms “base station” and “cell” interchangeably as there is one-to-one correspondence between them.

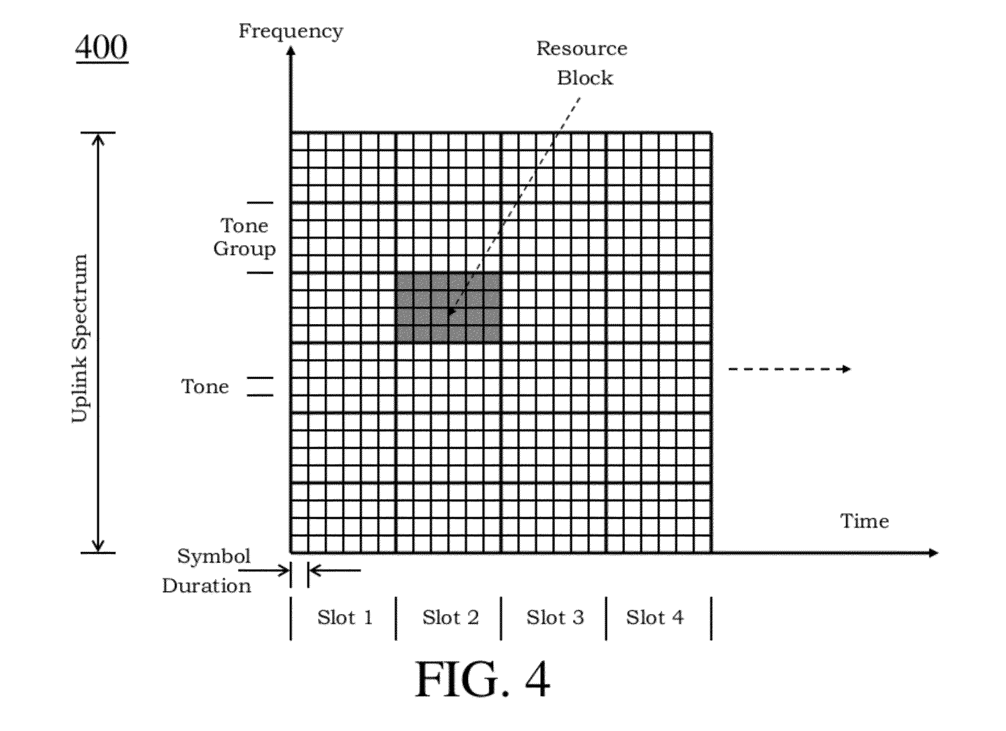

In an exemplary embodiment of our proposed approach, we assume that uplink transmissions use Orthogonal Frequency Domain Multiple Access (OFDMA); in another embodiment, Single Carrier-Frequency Domain Multiple Access (SC-FDMA) transmission technology is employed. These technologies typically use slotted transmissions with at least loose synchronization between transmissions emanating from different devices participating in the system. The spectrum available for uplink transmissions is divided into multiple sub-carriers or tones. FIG. 4 illustrates how transmission resources are typically organized for uplink (or downlink) communications in OFDMA and SC-FDMA systems. As shown in diagram 400, time is divided into slots (also referred to in literature as frames, sub-frames, etc.) Each slot comprises N_{S} symbol durations. Along the frequency dimension, the available spectrum comprises N_{T} tones or sub-carriers. The N_{T} tones are divided into N_{R} groups, each comprising M(=N_{T}/N_{R}) tones. A resource block consists of M tones belonging to a group repeated over the N_{S} symbol durations in a slot. Thus, a resource block comprises MXN_{S} modulation symbols, each identified by a specific combination of symbol index (on the time axis) and tone index (on the frequency axis). The basic unit for transmission resource allocation is a resource block. It is easy to see that there are N_{R} resource blocks associated with a slot.

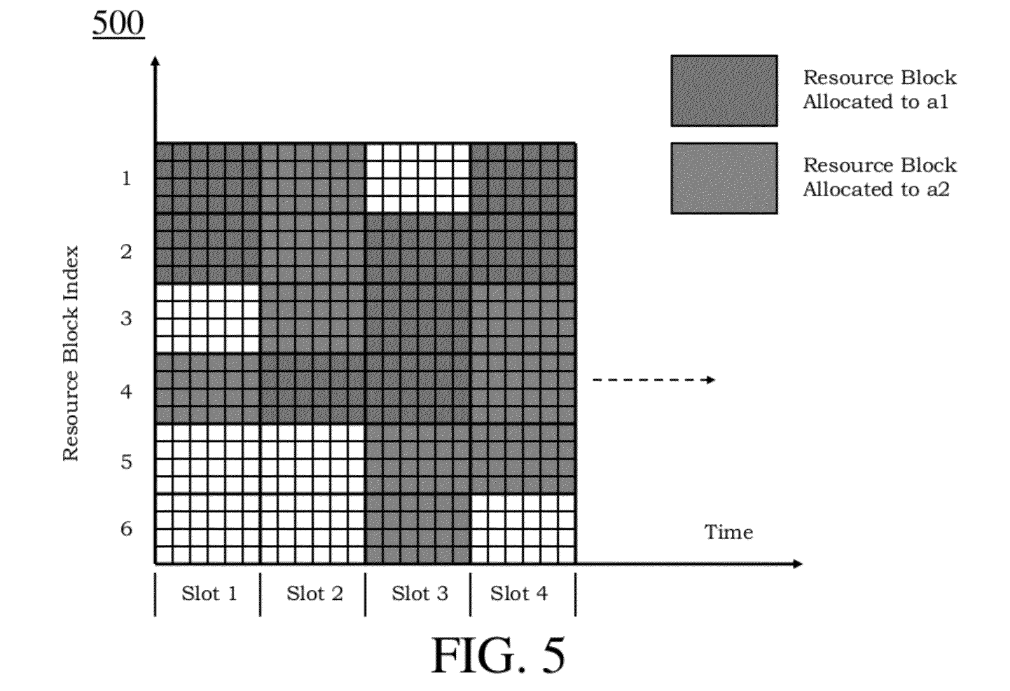

When a base station schedules uplink transmissions for a slot, it selects one or more mobile stations connected to it for transmission over that slot, and then allocates one or more resource blocks (associated with that slot) to each of them. For instance, as shown in diagram 500 of FIG. 5, in slot 1, base station A has allocated resource blocks 1 and 2 to mobile station al and resource block 4 to mobile station a2. (Resource block 3 has been left unused during slot 1.) In slot 2, mobile station a2 has been allocated resource blocks 1-3 and resource block 4 has been allocated to mobile station a1, and so on. Each base station prepares the schedule for uplink transmissions for a given slot sufficiently in advance and then sends the corresponding transmission grants (along with details of the modulation and coding scheme—MCS—to be used) to the concerned mobile stations over the appropriate downlink control channel. Note that in an SC-FDMA system, the tones in a resource block as well as the resource blocks allocated to the same mobile station during a slot have to be contiguous. There are no such restrictions in an OFDMA system. In order to keep the description simple, we assume that whenever a mobile station is allocated multiple resource blocks within the same slot, each of these resource blocks constitutes a separate coding block; i.e. each of them can be decoded independently.

Based on the transmission grants (for a given slot) received from their primary base stations, the mobile stations transmit their uplink signals as follows:

For each resource block allocated to it, the mobile station selects an appropriately sized chunk of information bits, and adds cyclic redundancy check (CRC) bits to it. It then encodes the information bits with CRC using the coding scheme indicated in the transmission grant, and uses the resulting coded symbols to modulate the tones in the resource block. (A tone modulated by a symbol is referred to as a modulation symbol.) Note that the modulation symbols in a resource block are divided into two subsets: bearer symbols and reference symbols. The reference symbols, also referred to as pilot symbols, are modulated with known signals (typically, symbols in a known sequence) and used by the base station receiver to generate channel estimates. The bearer symbols are tones that are modulated by coded symbols as described above. (We refer to the tones modulated by coded symbols as bearer tones.) The coded symbols may be interleaved before they are used to modulate bearer tones. In an OFDMA system, the (possibly interleaved) coded symbols are used to directly modulate the tones in the frequency domain, whereas in an SC-FDMA system an extra processing step involving the computation of a Discrete Fourier Transform (DFT) is involved. Finally, in each symbol duration within the slot, the mobile station computes the time-domain representation of modulation symbols associated with that symbol duration before transmitting the resulting signal waveform over the uplink channel.

Let us now consider the actions that take place at the various base station receivers in the cellular network. We assume that cells (and the corresponding base stations) are organized in clusters, each cluster comprising one or more neighboring cells. For instance, as shown in FIG. 2, cells 1, 2, 3, 4, 5, 6, and 7 constitute one cluster of cells; cells 10, 20, 21, 22, 11, 3, and 9 constitute another cluster of cells and so on. The clusters can be overlapping or non-overlapping. In a cellular network with non-overlapping clusters, each cell belongs to exactly one cluster. With overlapping clusters, a cell can belong to one or more clusters. Our approach does not place any restriction on clusters; i.e. clusters can be overlapping or non-overlapping. Each cell has a primary cluster associated with it. In the case of non-overlapping clusters, the primary cluster associated with a cell is the only cluster to which it belongs. In the case of overlapping clusters, the primary cluster associated with a cell is one of the (possibly several) clusters to which the cell belongs. Each cluster has a processor associated with it, where the signal processing and decoding operations for the signals received at base stations in the cluster take place. The primary cluster associated with a cell (i.e. the processor associated with that cluster) is primarily responsible for decoding the signals transmitted by mobile stations in the cell, although it is possible for other clusters to decode these signals and forward them to the primary cluster associated with the cell.

Getting back to the actions of base station receivers in accordance with various embodiments of the present invention, we note that during each symbol duration within a slot, the base station receiver processes the received signal waveform by performing on it filtering, sampling and other processing operations to extract received signal samples corresponding to each modulation symbol associated with that symbol duration. These operations are repeated during each symbol period in the slot to extract received signal samples corresponding to modulation symbols transmitted in the slot. The received signal samples associated with all symbol durations within a slot are collected to form a received signal vector for the slot. Note that in the case of a base station with multiple receive antennas, a separate received signal vector is formed for each of its antennas. The operations involved in constructing a received signal vector are well known to those familiar with the art.

Thus, we note that at the end of a slot the receiver has constructed a received signal vector for each receive antenna of the base station. Each received signal vector has one entry for each modulation symbol in the slot; i.e. it has N_{T}XN_{S} entries since the uplink spectrum has been divided into N_{T} tones and there are N_{S} symbol durations within a slot. The base station sends the received signal vectors to the processor associated with each cluster to which it (i.e. the base station or the associated cell) belongs. Thus, if each base station has L receive antennas, it sends L received signal vectors to the processor associated with each cluster to which it belongs, and each of these vectors has N_{T}XN_{S} entries.

We refer to the processor associated with a cluster as a cluster processor. Also, we use the same index to refer to a cluster as well as the associated cluster processor. Thus, for instance, the cluster processor associated with cluster p is referred to as cluster processor p and vice versa. Now, let us consider what happens at the processor associated with a cluster. Assuming that the cluster consists of K cells, each of which is equipped with L receive antennas, the cluster processor, at the end of a slot, has K·L received signal vectors, each consisting of N_{T}XN_{S} entries.

For each resource block n (1≦n≦N_{R}) in the just-completed slot, the cluster processor (say cluster processor p) identifies two sets of mobiles, Sₙ and Tₙ, defined as follows: Sₙ is the set of mobiles transmitting over resource block n that belong to cells included in cluster p, and Tₙ is the subset of this set comprising mobiles in cells for which cluster p is the primary cluster. Cluster processor p computes channel estimates for all mobiles in the set Sₙ. Let j be one such mobile (i.e. mobile j belongs to the set Sₙ.) Then, cluster processor p computes channel estimates for the channel (for resource block n) between the transmit antenna(s) associated with mobile j and each receive antenna in cluster p. In order to avoid complicating the description of various embodiments, we assume that each mobile has a single transmit antenna. However, our approach also applies to the case of mobiles with multiple transmit antennas.

Since there are K cells in the cluster, each with L receive antennas, for a mobile transmitting over a given resource block, the channel coefficients are represented by a K·L dimensional vector for the case being described (i.e. where each mobile is equipped with one transmit antenna.) Specifically, let ĥ_{j,k,l}(n) denote the estimate of the channel between (the only transmit antenna of) mobile j and the l^{th} receive antenna of the k^{th} cell for resource block n. Then the K·L dimensional vector of channel estimates for mobile j over resource block n is given by:

ĥⱼ(n)=[ĥ_{j,1,1}(n), ĥ_{j,1,2}(n), . . . , ĥ_{j,1,L}(n), ĥ_{j,2,1}(n) . . . , ĥ_{j,2,L}(n), . . . , ĥ_{j,K,1}(n), . . . , ĥ_{j,K,L}(n)], (4)

where, for convenience, the K cells in the cluster are numbered 1 through K, and the receive antennas in each cell are numbered 1 through L. Cluster processor p computes the individual channel estimates, ĥ_{j,k,l}(n), by processing the received signal samples collected by the appropriate antenna that correspond to the reference symbols associated with resource block n. For instance, the channel estimate ĥ_{j,1,1}(n) is computed by processing the received signal samples corresponding to the reference symbols associated with resource block n that were collected by receive antenna 1 of cell 1. The exact details of this computation are well known to those familiar with the art.

Now, in one embodiment of the invention, for each resource block in the just-completed slot, cluster processor p does the following:

For each mobile j in the set Tₙ (i.e. the set of mobiles transmitting over resource block n which belong to cells for which the cluster being considered is the primary cluster), the cluster processor forms the SINR-maximizing beamforming vector wⱼ(n), given by:

$${w}_{j} ( n ) = {[ {σ}^{2} {I}_{K \cdot L} + {\sum }_{i ɛ {S}_{n} , i \neq j} {p}_{i} ( n ) {\hat{h}}_{i} ( n ) {{\hat{h}}_{i} ( n )}^{†} ]}^{- 1} {\hat{h}}_{j} ( n ) , \qquad ( 5 )$$

where the symbol “^{†}” represents the conjugate-transpose of the matrix or vector preceding it, pᵢ(n) is the average per-bearer-symbol power for mobile i over resource block n, σ² is the sum of the variance of the complex Gaussian thermal noise present in the received signal samples and the average per-symbol received power from all mobile transmitting over resource block n except those included in the set Tₙ, and I_{K·L} is an identity matrix with K·L rows and columns (The optimum beamforming vector is given by eq. (5) if the channel estimate vectors are noiseless or have a very high signal-to-noise ratio. In the more general case, where channel estimate vectors are noisy, the matrix “σ² I_{K·L}” in eq. (5) may be augmented to account for the noise in channel estimates.) The beamforming vector wⱼ(n) is also known in the literature as the Minimum-Mean-Squared-Error (MMSE) beamforming vector.

Then, for each resource block n in the just-completed slot, cluster processor p forms sample vectors associated with each bearer symbol in the slot. The sample vector associated with a bearer symbol contains received signal samples collected by the receive antennas of the base stations included in the cluster. Since there are K·L receive antennas that forward their received signal samples to the cluster processor, the sample vector associated with a bearer symbol has K·L entries. Let rₘ(n) denote the K·L dimensional sample vector associated with the m^{th} bearer symbol in resource block n.

Next, for each mobile j in the set Tₙ, cluster processor p obtains a vector of soft symbols by processing the sample vectors associated with the bearer symbols in resource block n in combination with the beamforming vector wⱼ(n). Specifically, for each bearer symbol m, the cluster processor computes the dot product wⱼ(n)^{†}·rₘ(n) to obtain the corresponding soft symbol s_{j,m}(n):

s_{j,m}(n)=wⱼ(n)^{†}·rₘ(n). (6)

Let sⱼ(n) denote the vector of these soft symbols (s_{j,m}(n)) obtained as shown in equation (6). The cluster processor feeds the vector of soft symbols to a decoder to extract an estimate of the information bits transmitted by mobile j over resource block n. The decoding process is usually deemed successful if the estimate of information bits passes a cyclic redundancy check.

For each resource block n, cluster processor p performs the just-described operations of soft symbol vector generation and decoding on every mobile in set Tₙ. These actions mark the end of a stage in the actions of cluster processor p.

In accordance with various embodiments of the present invention, when a cluster processor completes the operations of symbol vector generation and decoding as described above, it does the following:
A) For each successful decoding attempt, it passes the decoded information bits to the higher layers so that they can be forwarded to their ultimate destinations. It also keeps, in its local buffers, a copy of the information bits along with details of the slot and resource block indices and the Modulation and Coding Scheme (MCS) used to transmit those bits.
B) For each unsuccessful decoding attempt, it stores the sample vectors associated with the corresponding bearer symbols in local buffers. The expectation is that it may be possible to refine these sample vectors via interference cancellation, thus improving their decodability. It also saves the estimates of channel coefficients associated with all the mobiles belonging to cells in the associated cluster that transmitted over the same slot.

We refer to this point as the end of the first round of decoding. At the end of this round of decoding, cluster processor p prepares a request message, which includes the following:

For every resource block n, if the cluster processor p has at least one mobile j belonging to the set Tₙ whose transmitted signal over resource block n was not successfully decoded in the previous round, it (i.e. the cluster processor p) includes a request for information bits (and the corresponding details about the slot, resource block and MCS used) associated with every mobile in the set Sₙ which was not successfully decoded by cluster processor p (by the end of the just-concluded round of decoding.)

For every cluster with which it has at least one cell in common, cluster processor p sends this request message to the processor associated with that cluster.

After sending the request messages as described above, cluster processor p enters a wait state. In the wait state, it receives request messages from other cluster processors indicating which sets of information bits (and related slot, resource block and MCS details) those cluster processors are interested in. (Some such request messages may arrive even before cluster processor p has entered the wait state. If that happens, it stores them in local buffers and takes them up for processing when it enters the wait state.) The cluster processor may also receive decoded data messages sent by other cluster processors in response to the request messages they received from cluster processor p. Cluster processor p processes the two types of messages as follows:

Cluster processor p prepares a decoded-data message in response to a request message received from another cluster processor. This decoded-data message is prepared as follows: Cluster processor p first identifies, for each resource block indicated in the request message, the mobile stations for which the information bits transmitted over the resource block are being requested. For each such mobile station that belongs to a cell for which cluster p is the primary cluster, if cluster processor p has the information bits transmitted by that mobile station over the indicated resource block (because of successful decoding), it includes the decoded information bits (and the relevant details of slot, resource block and MCS) in the decoded-data message being prepared. After preparing the decoded-data message, cluster processor p sends it to the cluster processor that requested the information bits included in the message.

In the wait state, cluster processor p simply stores in a local buffer all the decoded-data messages received from other cluster processors. When cluster processor p gets out of the wait state, it processes the stored decoded-data messages as follows:

Each decoded-data message stored in a local buffer by cluster processor p carries one or more sets of information bits together with allied information regarding the MCS and the resource blocks used to transmit those information bits. (A set of information bits refers to the information bits transmitted by a mobile station over a resource block.) When cluster processor p takes up a decoded-data message for processing, it checks each set of information bits separately. If a set of information bits has already been used for interference cancellation or if the associated resource block is such that the transmissions over that resource block by all mobiles in cells for which cluster p is the primary cluster have been successfully decoded, that set of information bits is discarded. Otherwise, the cluster processor p processes the set of information bits as follows:

Using the information bits and the corresponding MCS, cluster processor p reconstructs the coded symbols that were used to modulate the bearer tones in the corresponding resource block. (Bearer tones are the sub-carriers or tones on which the bearer symbols are carried.) Next, using the appropriate vector of channel estimates (i.e. one that corresponds to the mobile station and resource block associated with the set of information bits being processed) and the coded symbols, it constructs estimates of the corresponding received signals vectors. For instance, let the set of information bits being processed be associated with mobile j and resource block n. (That is, they represent the information bits transmitted by mobile j over resource block n.) The corresponding vector of channel estimates is denoted by ĥⱼ(n). (Recall that this is a K·L dimensional vector.) Then if x_{m,j}(n) is the coded symbol associated with the m^{th} bearer tone transmitted by mobile j over resource block n, the corresponding estimate of received signal vector is given by

ŕ_{m,j}(n)=ĥⱼ(n)x_{m,j}(n). (7)

Cluster processor p then subtracts a weighted value of the estimate of received interference signal vector from the corresponding signal sample vector rₘ(n) in order to refine the latter:

rₘ(n)←rₘ(n)−diag(α_{m,j}(n))ŕ_{m,j}(n). (8)

where diag(α_{m,j}(n)) is a diagonal weighting matrix whose diagonal entries represent weighting factors that are selected to minimize the effect of noise in the channel estimates. (The weighting factors depend on the method used to calculate channel estimates. For MMSE channel estimates, the weighting factors are all equal to 1; for correlation based channel estimates the weighting factors are typically less than 1.) In this manner, cluster processor p refines the signal sample vectors associated with all bearer symbols in resource block n by cancelling the interference caused by the transmissions of mobile j over that resource block.

In a similar manner, cluster processor p carries out interference cancellation using all sets of information bits in it local buffers that were not previously used for interference cancellation. It also carries out interference cancellation using the information bits it has decoded in the previous round of decoding.

After carrying out interference cancellation as described above, cluster p updates the beamforming vectors associated with all mobiles in the set Tₙ whose transmissions have yet to be successfully decoded. This updating is carried out to reflect the fact that since the interference caused by some of the mobiles has been cancelled from the received signal samples, the computation of the beamforming vectors should take into account the resulting reduction in the level of interference affecting the corresponding received signal samples.

This marks the end of the interference cancellation phase (of the current round of decoding.) At this point, cluster processor p discards the decoded-data messages in its local buffers. Note that at the end of all of this processing, cluster processor p has a refined signal sample vector for each bearer symbol in those resource blocks for which interference cancellation was carried out as described earlier.

Then, for each resource block n in the just-completed slot for which interference cancellation was carried out, cluster processor p performs the following actions:

If a mobile station, say j, in a cell belonging to the set Tₙ transmitted over resource block n and that transmission has not been successfully decoded, cluster processor p computes, for each bearer symbol m, the dot product between the refined values of the beamforming vector wⱼ(n) and signal sample vector rₘ(n) to obtain the corresponding soft symbol s_{j,m}(n). Note that this computation is exactly as shown in equation (6) except that at this stage the post-cancellation (refined) values of the beamforming vector and signal sample vectors are used. The cluster processor p feeds the vector of soft symbols to a decoder to extract an estimate of the information bits transmitted by mobile j over resource block n. Once again, the decoding process may or may not be successful. In case the decoding is successful for the transmissions of mobile j over resource block n, the successfully decoded information bits are passed on to the higher protocol layers and a copy of these bits along with details of the resource block index and the MCS used are saved in a local buffer. If the decoding is unsuccessful, cluster processor p saves the refined signal sample vectors associated with all bearer symbols in the resource block as well as the refined value of the beamforming vector in its local buffers.

Cluster processor p carries out this process of soft symbol formation and decoding on all transmissions associated with mobiles in cells belonging to set Tₙ that were not successfully decoded at the end of the previous round of decoding and that took place over resource blocks which underwent interference cancellation.

Next, cluster processor p prepares a request message, which includes the following:

For every resource block n, if cluster processor p has (after the just-completed round of decoding) at least one mobile j belonging to the set Tₙ whose transmitted signal over resource block n was not successfully decoded, it (i.e. cluster processor p) includes a request for information bits (and the corresponding details about the MCS used) associated with every mobile in the set Sₙ which have not yet been successfully decoded by cluster processor p or which it has not received from any other cluster via decoded-data messages.

The cluster processor p sends this request message to the processor associated with every cluster with which it has at least one cell in common. Note that in combination with the request messages sent previously, the new request message also acts as an acknowledgement of information bits received from other cluster processors.

After preparing and sending the request messages as described above, the cluster processor p enters a wait state just as it did after the previous round of decoding. This cycle of sending request messages, entering the wait state, receiving decoded-data messages, carrying out interference cancellation and decoding continues until either all transmissions from mobiles in cells for which cluster p is the primary processor have been successfully decoded or a pre-set upper limit on the number of such cycles is reached. At this point, cluster processor p clears all data, tables, buffers, etc., associated with the slot and informs the higher layers about coding blocks that could not be successfully decoded, thus ending all the physical layer processing associated with the slot being considered.

Note that in some embodiments, cluster processor p tries to decode the transmissions of only those mobiles that are in cells for which cluster p is the primary cluster. This means that the transmissions of a mobile get decoded at a unique cluster processor, namely the one associated with the mobile's primary cluster. In an other embodiments, each cluster processor tries to decode the transmissions of all mobiles that are in cells belonging to the associated cluster. Since a cell can belong to multiple clusters, what this means is that multiple cluster processors can attempt decoding the transmissions of a mobile station. The mobile station's transmissions will have been successfully decoded if any of these cluster processors succeeds at their decoding attempt. As a result, the packet error rate of the overall system is likely to improve at the expense of some extra processing that needs to be carried out at each cluster processor.

In some embodiments of the present invention, a cluster processor, say p, computes channel estimate vectors associated with mobiles (transmitting over different resource blocks) that belong to cells in cluster p. In other embodiments, each cluster processor p expands the set of mobiles for which it computes channel estimate vectors by including some of the mobiles that belong to cells not included in cluster p. These mobiles typically belong to cells that are just outside cluster p, and their transmissions can cause significant interference at base stations in cluster p that are close to those mobiles. If the signal-to-interference+noise-ratio (SINR) associated with the channel estimate vectors corresponding to some of these mobiles is reasonably high, cluster processor p can include them in the computation of the beamforming vector by expanding the set over which the summation in equation (5) is computed. Cluster processor p will also include in its request messages a request for information bits transmitted by these mobiles in case the interference caused by them causes the corresponding decoding attempts to fail. And, when these information bits are received from cluster processors (where they were successfully decoded), it can use them for carrying out interference cancellation in exactly the same way interference cancellation is performed using information bits associated with mobiles belonging to cells in cluster p. It is easy to see that these embodiments simply expand the set of mobiles that are included in interference cancellation and computation of the beamforming vectors.

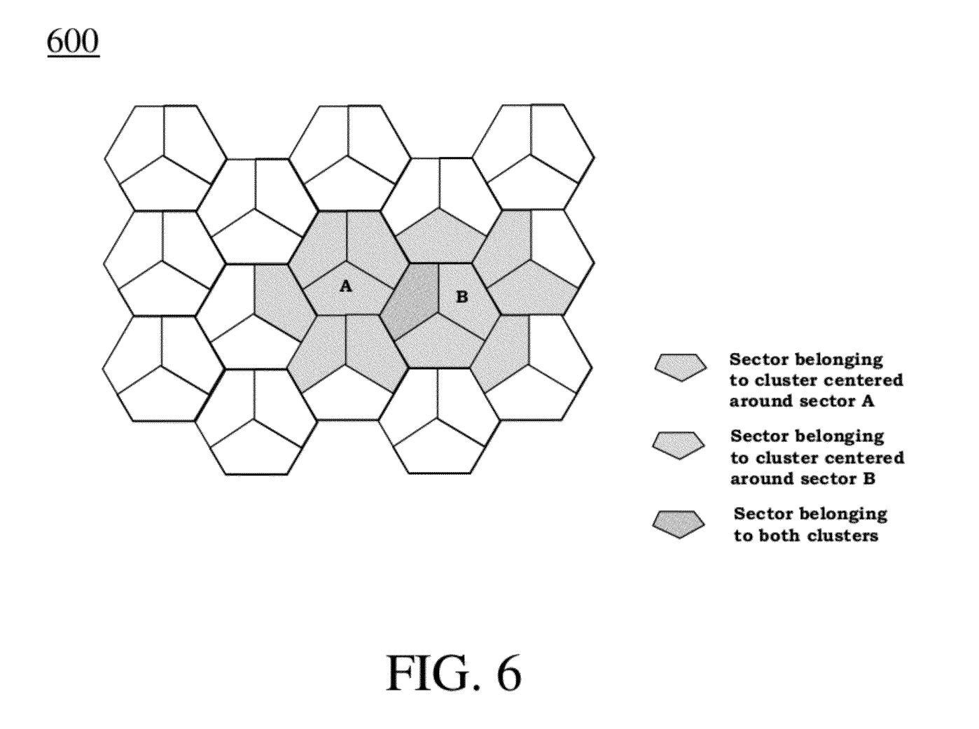

The above descriptions of the various embodiments of the present invention assumed base stations with omni-directional antennas. The present invention is not limited to cellular networks with such base stations. It is easy for anyone familiar with the art to see how it naturally extends to networks where base stations are equipped with sectorized antennas. Specifically, by treating each antenna sector at a base station as if it were an independent base station and the coverage area associated with this sector as the corresponding cell, one can apply our approach to cellular networks comprising base stations with sectorized antennas as well. Diagram 600 of FIG. 6 depicts an example of a cellular network where each base station has a 3-sector antenna so that the coverage area of a base station (i.e. a cell) is divided into 3 sectors—one corresponding to each of the base station's antenna sectors. FIG. 6 also shows how clusters may be formed in this case.

The embodiments presented in the next section are a special case of various embodiments that have a great deal of practical value. They involve base stations with sectorized antennas.

### Special Case

Here, we describe a special case of some of the embodiments described in the previous section that has a great deal of practical value. In this special case, base stations in the cellular network have sectorized antennas so that the coverage area associated with a base station, i.e. the corresponding cell, is divided into multiple sectors (referred to as cell sectors)—one corresponding to each antenna sector of the base station.

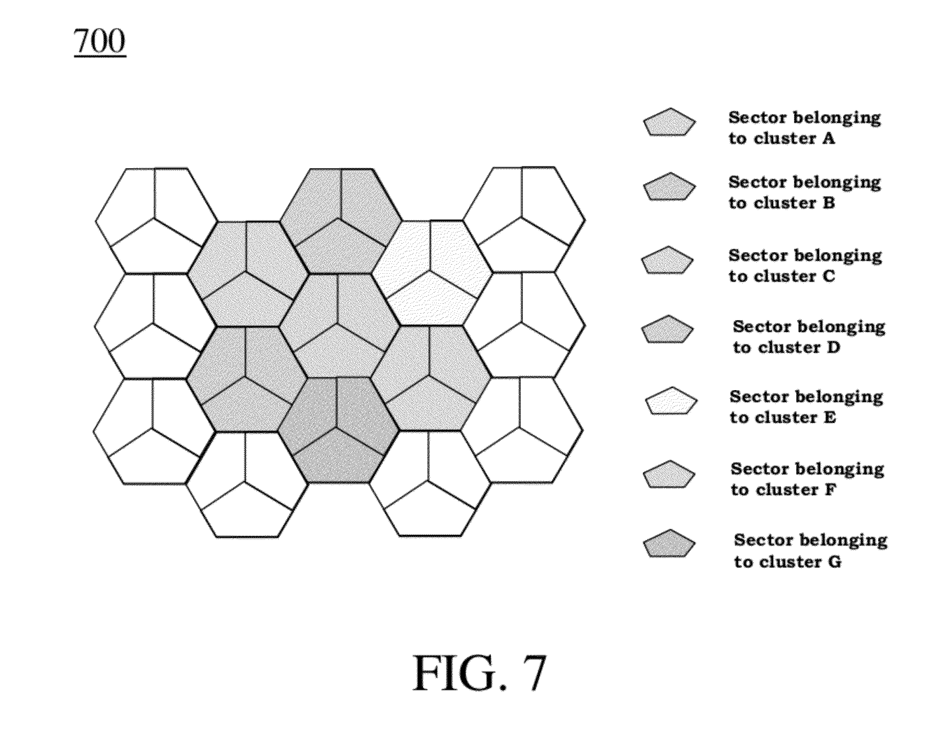

Cluster formation for receiver signal processing and decoding is done as follows: All cell sectors associated with a base station constitute a cluster, and no cluster includes cell sectors associated with more than one base station. For instance, FIG. 7 shows a cellular network where each cell (the coverage area associated with a base station) is divided into three sectors, and the three sectors of each such cell constitute a unique cluster. Thus, for Network MIMO processing of received signal samples, all the antennas at a base station are treated as a single antenna array, and the signal samples collected by this antenna array are jointly processed/decoded at the cluster processor located at the base station.

A second feature of cluster formation in this case is that clusters are non-overlapping. (This is a direct consequence of the requirement that a cluster cannot include cell sectors associated with more than one base station.) Since a cell sector belongs to exactly one cluster, that cluster has to be its primary cluster as well. This also means, in the notation introduced in the previous section, that from the viewpoint of the cluster processor associated with a base station, for every resource block n the sets Sₙ and Tₙ are identical. In other words, for every resource block, the cluster processor associated with a base station attempts to decode the signals transmitted by every mobile station that is connected to it and that transmitted over that resource block.

In these special case embodiments, the cluster processor at a base station computes channel estimates for mobiles connected to that base station as well as those connected to a few neighborhood base stations. For instance, consider the example illustrated in FIG. 7. For convenience, we shall use the same identifier to refer to a cluster as well as the base station associated with the cluster. (For example, the base station associated with cluster A is referred to as base station A.) In the example depicted by diagram 700, the cluster processor associated with cluster A attempts to compute channel estimates for mobiles connected to base station A as well as those that are connected to base stations B, C, D, E, F and G. Also, after attempting to decode the transmissions from mobiles connected to base station A, if the cluster processor finds that it was unable to successfully decode some of these transmissions, it sends request messages for decoded data to the cluster processors located at all of these base stations (i.e. base stations B through G). It then carries out interference cancellation and another round of decoding if it receives successfully decoded information bits from these neighboring cluster processors. This process continues, as described earlier, until either all transmissions are successfully decoded or an upper limit on the number of rounds of decoding is reached.

It is easy to see that the system described above is a special case of the embodiments where a cluster processor requests (for interference cancellation) decoded data (i.e. information bits) that is associated with mobile stations that belong to cells that are not included in the corresponding cluster.

The principal benefits of this special case are as follows: By limiting clusters to sectors associated with the same base station, it avoids moving signal samples between base stations, thus significantly reducing the load on the backhaul links. Limiting clusters to sectors associated with the same base station does somewhat reduce the gain one expects out of a Network MIMO system. However, the expanded role of multi-cell SIC in this case is expected to mitigate this loss. (This is due to the fact that interference cancellation is attempted using data associated with mobiles that are outside of the cluster.) Overall, it is expected that such embodiments would strike a good balance between the gains achievable via Network MIMO techniques and the need to minimize the load on the backhaul links.

The detailed and, at times, very specific description above is provided to effectively enable a person of skill in the art to make, use, and best practice the present invention in view of what is already known in the art. In the examples, the present invention is described in the context of specific architectures, specific system configurations and specific wireless signaling technologies for the purpose of illustrating possible embodiments and a best mode for the present invention. Thus, the examples described should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method comprising:
performing, by a first cluster processor of a first cluster, joint processing of received signal vectors, each corresponding to a receive antenna associated with the first cluster;
sending, by the first cluster processor, messaging requesting information from a second cluster processor to aid the first cluster processor in decoding signals from a transmitting device.

2. The method as recited in claim 1, further comprising
receiving, by the first cluster processor in response to the messaging requesting information, decoded information bits corresponding to at least one interfering device.

3. The method as recited in claim 2, further comprising
employing, by the first cluster processor, interference cancellation using at least a portion of the decoded information bits received in an attempt to decode signals from the transmitting device.

4. The method as recited in claim 1, further comprising
receiving, by the first cluster processor from another cluster processor, messaging requesting information to aid that other cluster processor in decoding signals.

5. The method as recited in claim 4, further comprising
identifying, based on the received messaging, at least one interfering device for which the first cluster processor has decoded information bits;
responding to the received messaging with decoded information bits corresponding to the at least one interfering device.

6. The method as recited in claim 1, wherein the first cluster comprises at least one of a plurality of sectors or a plurality of cells.

7. The method as recited in claim 1, wherein the first cluster comprises sectors associated only with the same base station.

8. An article of manufacture comprising a processor-readable storage medium storing one or more software programs which when executed by one or more processors performs the steps of the method of claim 1.

9. A cluster processor of a first cluster in a communication system, the cluster processor being configured to communicate with other devices in the system, wherein the cluster processor is operative
to perform joint processing of received signal vectors, each corresponding to a receive antenna associated with the first cluster, and
to send messaging requesting information from a second cluster processor to aid the present cluster processor in decoding signals from a transmitting device.

10. The cluster processor as recited in claim 9, wherein the cluster processor is further operative
to receive, in response to the messaging requesting information, decoded information bits corresponding to at least one interfering device.

11. The cluster processor as recited in claim 10, wherein the cluster processor is further operative
to employ interference cancellation using at least a portion of the decoded information bits received in an attempt to decode signals from the transmitting device.

12. The cluster processor as recited in claim 9, wherein the cluster processor is further operative
to receive, from another cluster processor, messaging requesting information to aid that other cluster processor in decoding signals.

13. The cluster processor as recited in claim 12, wherein the cluster processor is further operative
to identify, based on the received messaging, at least one interfering device for which the first cluster processor has decoded information bits;
to respond to the received messaging with decoded information bits corresponding to the at least one interfering device.

14. The cluster processor as recited in claim 9, wherein the first cluster comprises at least one of a plurality of sectors or a plurality of cells.

15. The cluster processor as recited in claim 9, wherein the first cluster comprises sectors associated only with the same base station.
